(19) United States
(12) Patent Application Publication
(10) Pub. No.: US 2019/0096246 A1
(43) Pub. Date: Mar. 28, 2019

(54) COMPACT MODULAR WIRELESS SENSING RADAR INFRASTRUCTURE DEVICE

(71) Applicant: Continental Automotive Systems, Inc., Auburn Hills, MI (US)

(72) Inventors: Bastian Walter Zydek, Bad Soden (DE); Ibro Muharemovic, Warren, MI (US); Joshua Frankfurth, Rochester Hills, MI (US)

(73) Assignee: Continental Automotive Systems, Inc., Auburn Hills, MI (US)

(21) Appl. No.: 16/139,821

(22) Filed: Sep. 24, 2018

Related U.S. Application Data
(60) Provisional application No. 62/562,855, filed on Sep. 25, 2017.

(51) Int. Cl. G08G 1/095; H04L 29/08

(52) U.S. Cl. CPC G08G 1/095; H04L 67/12

(57) ABSTRACT

A compact and modular wireless sensing radar infrastructure device, which is part of a system for warning vulnerable road users (i.e., pedestrians, cyclists, other, etc) that a vehicle or cyclist is approaching and there may be a potential danger of a collision, and the system also provides an alert to an oncoming vehicle or cyclist of the location of a vulnerable road user within a cross-walk or intersection.

### CROSS-REFERENCE TO RELATED APPLICATIONS

This application claims the benefit of Provisional Application 62/562,855, filed Sep. 25, 2017. The disclosure of the above application is incorporated herein by reference.

### FIELD OF THE INVENTION

The invention relates generally to modular device used as part of a system for detecting objects and broadcasting information about the detected objects in multiple applications.

### BACKGROUND OF THE INVENTION

Signalized and unsignalized intersections and cross-walks for pedestrians present one of the most dangerous areas where accidents may occur, such as an automobile hitting a pedestrian. Additionally, pedestrians are also distracted by cell phones, tablet computers, billboards, other pedestrians, and the like, which may limit the ability of the pedestrian to be fully aware of any dangers resulting from vehicles that may be driving unsafely.

Currently, there are many types of systems in place, which are part of a vehicle, to make a driver of the vehicle aware of potential dangers with regard to collisions with pedestrians, other vehicles, and other objects along the side of a road. There are also some systems which are part of the infrastructure of an intersection, or the infrastructure of an area which has heavy traffic volumes, which are able to communicate with a vehicle to provide alerts of potential collisions with either pedestrians or other vehicles.

However, many of these systems which are used with various infrastructure components have multiple parts located in different areas of an urban environment, and are complex to integrate into local infrastructure.

Accordingly, there exists a need for device having several integrated components, where the device may be used as part of a warning system, and the system may be easily integrated with the infrastructure of an urban environment and used for broadcasting information regarding detected objects, and is suitable for use in multiple applications.

### SUMMARY OF THE INVENTION

The present invention is a compact and modular wireless sensing radar infrastructure device, which is part of a system for providing warnings and other types of information, such as warning vulnerable road users (i.e., pedestrians, cyclists, others, etc) that a vehicle or cyclist is approaching and there may be a potential danger of a collision, and the system also provides an alert to an oncoming vehicle or cyclist of the location of a vulnerable road user.

In one embodiment, intelligent intersections are equipped with device of the present invention and are enabled with dedicated short range communication (DSRC) for detecting vehicles and vulnerable road users, and the device is able to broadcast information about them as a basic safety message (BSM). This information may be received by DSRC-enabled vehicles and allow the vehicles to warn the drivers of various situations which may be potentially dangerous. The alert or information signal may include an audio warning given over loudspeaker, for alerting the vision impaired, a visual warning, or a haptic warning.

Since emergency brake assist (EBA) systems have sensors that may accurately determine the location, speed, and direction of objects (pedestrians, cyclists, etc), and may be equipped with V2x technologies and communicate with the smart city infrastructures, key information may be shared to allow for localized warnings in pedestrian/cyclist areas.

In one embodiment, the present invention is a modular one-box solution for infrastructure sensing which is flexible in use and easy to install/interface. Other embodiments of the present invention operate wirelessly.

In one embodiment, the present invention incorporates a radar sensor or array of sensors with attached communication hardware (options: e.g. Automotive DSRC/LTE and/or WiFi) to broadcast detected objects for multiple applications. The sensor may also be power supplied by a solar panel which would make this one box solution act fully wireless and thus very easy to integrate into the infrastructure where a one-box solution is used. The system is modular and may be modularly adapted (communication HW, power supply, detection SW) to the required use cases.

The compact and modular wireless sensing radar infrastructure device may be used in various applications, and is modular, wireless, and flexible allowing for installation in numerous locations. In one embodiment, the device may be mounted to an intersection infrastructure (poles, etc.) and detect vehicles and or pedestrians, bicycles, etc., and broadcast their speed, velocity, heading, via a communication channel to other traffic participants. Thus, those receiving participants are aware of the detected objects enabling ADAS functionalities, etc.

In one embodiment, the present invention is a modular warning device, which includes at least one sensor operable for detecting one or more objects in a detection area, where at least a portion of an intersection is located within the detection area. The modular warning device also includes at least one communication device in electrical communication with the sensor, at least one information device in electrical communication with the communication device, and at least one information signal produced by the information device. In one embodiment, the sensor, communication device, and information device are integrated into a single component.

In one embodiment, the communication device commands the information device to produce the information signal when the sensor detects when at least one vulnerable road user is crossing the intersection.

In another embodiment, a traffic signal is in communication with an interface device, and the interface device is in communication with the modular warning device. The interface device receives information from the modular warning device, and the interface device operates the traffic signal based on information received by the modular warning device, making use of such information to optimize the traffic signal switching.

In another embodiment, the modular warning device is mounted to at least one infrastructure component such that the modular warning device counts the number of vehicles passing through the detection area to obtain traffic count values, and broadcasts (e.g. via LTE) the traffic count values to a central station used for managing traffic (e.g. adaptive speed limits).

The at least one infrastructure component maybe any one of, but is not limited to, a bridge, a post, a building, a parking structure, or a support structure.

In another embodiment, the sensor of the modular warning device detects one or more accidents in the detection area, and the communication device reports information regarding the accidents (i.e., lane closures) to one or more vehicles. The modular warning device may be used for reporting such incidents via a wireless channel.

In one embodiment, an intersection or an area of a road may be an accident hot sport, and the modular warning device is located such that the accident hot spot is within the detection area.

In another embodiment, the sensor detects one or more congested freeway ramps, which are difficult to detect for vehicle sensors and drivers. The communication device and the information device transmit information regarding the congested freeway ramps to one or more approaching vehicles to initiate a warning.

In another embodiment, the modular warning device is mounted in proximity to a loading dock or cargo center to monitor and guide docking maneuvers of one or more vehicles.

In another embodiment, the modular warning device is located such that at least a portion of a parking lot is located within the detection area, and the modular warning device broadcasts whether one or more of the parking spaces in the parking lot is vacant.

In another embodiment, the modular warning device is mounted in one or more locations to detect irregular traffic patterns in a pedestrian-only area (such as vehicles in a pedestrian only area).

In one configuration, multiple modular warning devices may wirelessly communicate to a central processing unit fusing the information into one environmental understanding and giving that information to consuming units.

In one configuration, Neural Networks are trained for above mentioned scenarios are used for detection, etc.

In another embodiment, sensor raw/pre-processed data is sent to a central unit where NN are being used for detection.

In another embodiment, the modular warning device may be a part of intersection vehicle presence detection systems (i.e., camera, induction loops) which are hardwired to a traffic light controller.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a traffic intersection having a warning system which includes a compact and modular wireless sensing radar infrastructure device, according to embodiments of the present invention; and

FIG. 2 is a perspective view of a compact and modular wireless sensing radar infrastructure device used as part of a warning system, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

An example of a system for detecting and broadcasting information about different vehicles and vulnerable road users (VRU) is shown in the Figures generally at 10. There are several vulnerable road users (VRUs), shown generally at 12, travelling near an intersection, shown generally at 14. More specifically, there are two vulnerable road users 12A,12B attempting to cross the intersection 14 at a cross-walk, shown generally at 16. A first vehicle 18A is stopped near the cross-walk 16, and a second vehicle 18B is moving towards the intersection 14 in a direction that is perpendicular to the direction of travel of each of the VRUs 12A,12B.

The warning system 10 includes a compact and modular wireless sensing radar infrastructure device, shown generally at 20, where the modular device 20 is attached to some type of infrastructure component, which in this embodiment is a post, shown generally at 22. The modular device 20 includes at least one sensor 24, at least one communication device 26, and at least one information device 28. While in this embodiment, the infrastructure component is the post 22, it is within the scope of the invention that the warning system 10 may include any other type of infrastructure component, such as a building, bridge, parking structure, support structure, or the like.

In this embodiment, the communication device 26 is enabled with dedicated short range communication (DSRC) for transmitting information regarding detected vehicles and vulnerable road users. The sensor 24, communication device 26, and information device 28 are integrated into the modular device 20 as a single component or a single unit. The sensor 24 in this embodiment is able to detect objects in a detection area, shown generally at 24A. In one embodiment, the sensor 24 is a long-range radar sensor 24, but it is within the scope of the invention that other types of sensors maybe used, such as, but not limited to LIDAR (Light Imaging, Detection, and Ranging), LADAR (Laser Imaging, Detection, and Ranging), other types of radar, a camera, ultrasound, or sonar. The sensor 24 is able to send a signal to the communication device 26 providing an indication of the location, speed, and direction of any object (either pedestrian or vehicle) in the detection area 24A.

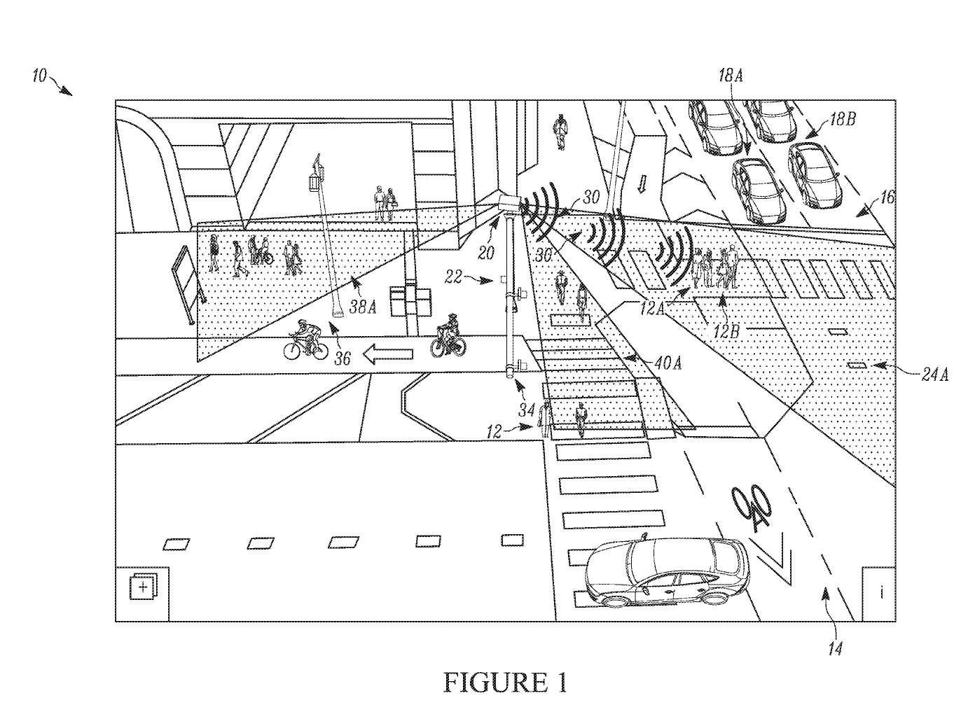

One embodiment of the modular device 20 includes providing a warning to one or more VRUs 12 of a vehicle approaching an intersection. In the example shown in the FIG. 1, the first vehicle 18A is blocking the view of each VRU 12A,12B crossing the intersection 14, such that each VRU 12A,12B is unable to see the second vehicle 18B approaching the intersection 14. If each VRU 12A,12B continues to walk through the intersection 14 unaware of the path of travel of the second vehicle 18B, or the driver of the vehicle 18B is unaware that the VRUs 12A,12B are attempting to walk through the intersection 14, the second vehicle 18B may collide with and seriously injure or kill one of the VRUs 12A,12B.

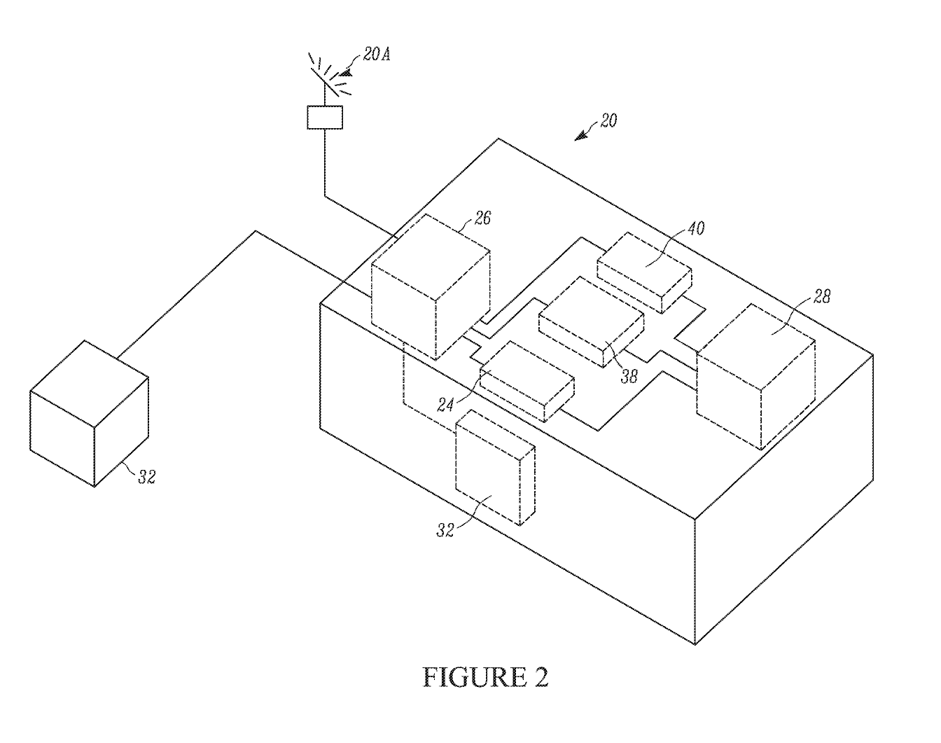

In the Figures, the sensor 24 is able to detect the location, as well as speed and direction of each vehicle 18A,18B, and the location, speed, and direction of each VRU 12A,12B. While there are two VRUs 12A,12B which are walking in the example shown in FIGS. 1-2, it is within the scope of the invention that the sensor 24 is able to detect if each VRU 12 is walking, traveling by bicycle, scooter, skateboard, rollerblades, or the like.

Once the sensor 24 detects the location, as well as speed and direction of each vehicle 18A,18B, and the location, speed, and direction of each VRU 12A,12B, the communication device 26 commands the information device 28 to produce a signal 30, which may be an alert signal or an information signal. The information device 28 may be equipped to send out different types of information signals 30, such as, but not limited to, an audible sound warning, a visual warning, or a haptic warning. In the embodiment shown in FIG. 1, the information signal 30 is an audible warning to alert each VRU 12A,12B that there is a potential risk of collision with the vehicle 18B.

The cross-walk 16 shown in FIG. 1 is located near the intersection 14. However, in an alternate embodiment, the modular device 20 may be used near a mid-block cross-walk that is not near an intersection, and a sign, such as an LED sign, may be used to inform one or more VRUs of an approaching vehicle.

In other embodiments, the information signal 30 may accommodate any type of VRU 12 traveling under various conditions. For example the VRU 12 may be deaf, listening to headphones, or have limited hearing ability due to some other condition, and require the information signal 30 to provide a visual warning, or in some embodiments, a haptic warning.

In one embodiment, the communication device 26 is a dedicated short range communication (DSRC) device 26, but it is within the scope of the invention that other types of communication devices maybe used. In one embodiment, each of the vehicles 18A,18B may be equipped with a DSRC-enabled communication device, suitable for communication with the communication device 26, but it is within the scope of the invention that other types of communication, such as LTE or WiFi, may be used.

The integration of the sensor 24, communication device 26, and information device 28 into the modular device 20 as a single component provides the advantage of more easily facilitating installation to various infrastructure components. The modular device 20 also facilitates use for different applications, such as, but not limited to, accident reconstruction, warning of VRUs of potential collisions, optimization of traffic signal operation, and detection of irregular traffic patterns.

The device 20 may be powered by a battery 32, where in one embodiment, the battery 32 is integrated along with the other components into the modular device 20, shown in FIG. 2. Also shown in FIG. 2, the battery 32 may be in a separate location from the device 20, such that the battery 32 may be mounted separately. The battery 32 may also be powered through the same power source that powers the traffic lights or other components that are part of the local infrastructure. Additionally, the device 20 may be powered by a solar panel, shown generally at 20A.

A traffic signal is also shown in FIG. 1, generally at 34, which in one embodiment is controlled by an interface device (not shown) mounted to the post 22. The interface device receives information from the device 20, making use of information regarding the movement of the VRU's 12 and the vehicles 18A,18B to optimize the operation of the traffic signal 34, facilitating the flow of traffic and safety of the VRU's 12. In another embodiment, the device 20 may be used to control the traffic signal 34 directly, without the use of the interface device.

In another embodiment, the device 20 is mounted to road infrastructure, such as the post 22 as described above, or building, bridge, parking structure, support structure, or other part of infrastructure, to perform a counting of the number of VRU's 12 and vehicles, and broadcast (e.g. via LTE using the communication device 26) the count values to a central station used for managing traffic (e.g. adaptive speed limits).

In another embodiment, the device 20 is located such that the device 20 is used for detecting accidents on lanes of the road, such as the intersection 14, and reports such incidents via the communication device 26.

In another embodiment, the device 20 is located such that the device 20 is used for detection of congestion on freeway/highway ramps, which is difficult to detect by sensors on a vehicle, or by vehicle drivers. The detection is then transmitted via the communication device 26 and the information device 28 to approaching vehicles, such that the drivers of the approaching vehicles may avoid the congested ramp.

In another embodiment, the intersection 14 may be an accident hotspot (i.e., locations where accidents occur more often), or the accident hotspot may be a curve or bend in the road. The device 20 is mounted in proximity to the accident hot spot, such that the information device 28 may be used to provide a warning to drivers of potentially over speeding in turns such that a warning to slow down could be issued, or a longitudinal deceleration could be initiated. A warning could also be provided to an oncoming car in tight areas such as narrow turns or bends, or a warning could be provided to cars turning from a driveway onto a roadway, etc.

In another embodiment, the device 20 is located in proximity to one or more loading docks or cargo centers, where the device 20 is used to monitor and guide docking maneuvers of trucks and other types of vehicles.

In another embodiment, the device 20 is mounted to infrastructure such that the device 20 is able to monitor and broadcast the availability of parking lots, and the availability of various parking spaces in the parking lots.

In another embodiment, the device 20 is mounted in one or more locations to detect irregular traffic patterns. Referring again to FIG. 1, there is a sidewalk, shown generally at 36, which is a pedestrian-only area (or an area designated only for use by VRUs 12). There is another sensor 38 having a detection area, shown generally at 38A, where at least a portion of the sidewalk 36 is located in the detection area 38A. The sensor 38 is able to detect an irregular traffic pattern, such as one or more of the vehicles 18A,18B traversing the sidewalk 36, which is a pedestrian-only area.

In one embodiment, there are multiple devices 20 which wirelessly communicate to a central processing unit, where the central processing unit fuses the information into one environmental understanding, or map the surrounding environment, and provide that information to consuming units, such as the vehicles 18A,18B, or each VRU 12.

In one configuration, Neural Networks trained for use in each above-mentioned embodiment are used for detection, communication, etc. In another embodiment, raw/pre-processed data received by the sensor 24 is sent to a central unit, where the Neural Networks are being used for detection.

In another embodiment, the intersection 14 includes a vehicle presence detection system (i.e., camera, induction loops), which is hardwired to a traffic light controller, and the device 20 is part of the vehicle presence detection system.

In each embodiment, there may also be an additional sensor 40, which is a blind spot sensor 40, and the blind spot sensor 40 is able to detect objects in a detection area 40A. The detection area 40A is a blind spot detection area 40A, where the sensor 40 is able to detect objects that may not be detectable by one of the other sensors 24,38. One or more blind spot sensors 40 may be used in any one of the embodiments mentioned above to detect objects that may not be detectable in the detection areas 24A,38A. Deer or other animals, construction workers in a construction zone, or other objects may be detected by the blind spot sensors 40.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a modular warning device, including:
at least one sensor operable for detecting one or more objects in a detection area, at least a portion of an intersection located within the detection area;
at least one communication device in electrical communication with the at least one sensor;
at least one information device in electrical communication with the communication device; and
at least one information signal produced by the at least one information device;
wherein the at least one sensor, at least one communication device, and at least one information device are integrated into a single component.

2. The apparatus of claim 1, wherein the at least one communication device commands the at least one information device to produce the at least one information signal when the at least one sensor detects when at least one vulnerable road user is crossing the intersection.

3. The apparatus of claim 1, further comprising:
a traffic signal; and
an interface device in communication with the traffic signal and the modular warning device;
wherein the interface device receives information from the modular warning device, and the interface device operates the traffic signal based on information received by the modular warning device.

4. The apparatus of claim 1, further comprising:
at least one infrastructure component, the modular warning device being mounted to the at least one infrastructure component;
wherein the device counts the number of vehicles passing through the detection area to obtain traffic count values, and broadcasts the traffic count values to a central station used for managing traffic.

5. The apparatus of claim 4, the at least one infrastructure component further comprising at least one of a bridge, a post, a building, a parking structure, or a support structure.

6. The apparatus of claim 1, wherein the at least one sensor of the modular warning device detects one or more accidents in the detection area, and the communication device reports the one or more accidents to one or more vehicles.

7. The apparatus of claim 6, further comprising an accident hot sport, wherein the modular warning device is located such that the accident hot spot is within the detection area.

8. The apparatus of claim 1, wherein the at least one sensor detects one or more congested freeway ramps, and the at least one communication device and the at least one information device transmit information regarding the one or more congested freeway ramps to one or more vehicles.

9. The apparatus of claim 1, further comprising a loading dock, wherein the modular warning device is mounted in proximity to the loading dock to monitor and guide docking maneuvers of one or more vehicles.

10. The apparatus of claim 1, further comprising a parking lot having a plurality of parking spaces, wherein the device located such that at least a portion of the parking lot is located within the detection area, and the modular warning device broadcasts whether one or more of the plurality of parking spaces is vacant.

11. The apparatus of claim 1, further comprising:
at least one pedestrian-only area;
wherein the modular warning device is mounted in one or more locations to detect irregular traffic patterns in the pedestrian-only area.

12. The apparatus of claim 1, further comprising:
a plurality of modular warning devices; and
a central processing unit;
wherein each of the plurality of modular warning devices wirelessly communicate with the central processing unit, such that the information received from each of the plurality of modular warning devices is used to map the surrounding environment, and information regarding the surrounding environment is provided to one or more vehicles.

13. The apparatus of claim 1, further comprising at least one neural networks in electrical communication with the communication device and the at least one sensor, wherein the at least one neural network performs a learning function to detect traffic patterns.

14. A modular warning device, comprising:
at least one sensor operable for detecting one or more objects in a detection area, at least a portion of an intersection located within the detection area;
at least one communication device in electrical communication with the at least one sensor;
at least one information device in electrical communication with the communication device, the at least one sensor, at least one communication device, and at least one information device are integrated into a single component; and
at least one information signal produced by the at least one information device;
wherein the at least one communication device commands the at least one information device to produce the at least one information signal when the at least one sensor detects when at least one vulnerable road user is in proximity to the intersection.

15. The modular warning device of claim 14, further comprising:
a traffic signal; and
an interface device in communication with the traffic signal and the modular warning device;
wherein the interface device receives information from the modular warning device, and the interface device operates the traffic signal based on information received by the modular warning device.

16. The modular warning device of claim 14, further comprising:
at least one infrastructure component, the modular warning device being mounted to the at least one infrastructure component;
wherein the device counts the number of vehicles passing through the detection area to obtain traffic count values, and broadcasts the traffic count values to a central station used for managing traffic.

17. The modular warning device of claim 14, the at least one infrastructure component further comprising at least one of a bridge, a post, a building, a parking structure, or a support structure.

18. The modular warning device of claim 14, wherein the at least one sensor of the modular warning device detects one or more accidents in the detection area, and the communication device reports the one or more accidents to one or more vehicles.

19. The modular warning device of claim 18, the intersection further comprising an accident hot sport, wherein the device is located such that the accident hot spot is within the detection area.

20. The modular warning device of claim 14, further comprising:
at least one pedestrian-only area located in proximity to the intersection;
wherein the modular warning device is mounted in one or more locations to detect irregular traffic patterns in the pedestrian-only area.

21. The modular warning device of claim 14, further comprising:
a plurality of modular warning devices; and
a central processing unit;
wherein each of the plurality of modular warning devices wirelessly communicate with the central processing unit, such that the information received from each of the plurality of modular warning devices is used to map the surrounding environment, and information regarding the surrounding environment is provided to one or more vehicles and the at least one vulnerable road user.

22. The modular warning device of claim 14, further comprising at least one neural network in electrical communication with the communication device and the at least one sensor, wherein the at least one neural network performs a learning function to detect traffic patterns.
